(19) United States
(12) Patent Application Publication
(10) Pub. No.: US 2019/0159302 A1
(43) Pub. Date: May 23, 2019

(54) MICROWAVE FEEDING SYSTEM

(71) Applicant: ELECTROLUX APPLIANCES AKTIEBOLAG, Stockholm (SE)

(72) Inventor: Gabriel Avram, Southend on Sea, Essex (GB)

(73) Assignee: ELECTROLUX APPLIANCES AKTIEBOLAG, Stockholm (SE)

(21) Appl. No.: 16/313,169

(22) PCT Filed: Jun. 21, 2017
(86) PCT No.: PCT/EP2017/065215

§ 371 Date: Dec. 26, 2018

(30) Foreign Application Priority Data
Jul. 1, 2016 (EP) 16177601.8

(51) Int. Cl. H05B 6/72; H05B 6/70; H05B 6/64

(52) U.S. Cl. CPC H05B 6/725; H05B 6/6408; H05B 6/6402; H05B 6/707

(57) ABSTRACT

A microwave feeding system (10) for a microwave oven or an oven with microwave heating function, wherein the microwave feeding system (10) comprises a magnetron (12), a rectangular waveguide (14) and a cylindrical cavity (18), the cylindrical cavity (18) is connected or connectable to an oven cavity (20), a rotatable omnidirectional antenna (22) is arranged inside the cylindrical cavity (18), the omnidirectional antenna (22) is driven by an antenna motor (24), the omnidirectional antenna (22) is connected to the antenna motor (24) via a shaft (30) made of conductive material, an inner cavity (26) is arranged inside the cylindrical cavity (18), the inner cavity (26) is arranged coaxially to the cylindrical cavity (18), the inner cavity (26) encloses at least partially the shaft (30), and the inner cavity (26) and the shaft (30) are arranged coaxially to each other, characterised in that the magnetron (12), the rectangular waveguide (14) and the cylindrical cavity (18) are connected in straight series, wherein the microwave feeding system (10) provides elliptically polarized TEM electromagnetic waves for the oven cavity (20), and wherein the omnidirectional antenna (22) acts as a continuous phase shifter, and wherein an inner diameter of the cylindrical cavity (18) is between 0.75 and three multiples of the wave-length of the microwaves guided within said cylindrical cavity (18).

The present invention relates to a microwave feeding system for a microwave oven or for an oven with microwave heating function according to the preamble of claim 1. Further, the present invention relates to a microwave oven or an oven with microwave heating functions.

Current microwave feeding systems provide a power efficiency of not more than about 55%, since a substantial amount of the power delivered by a magnetron is lost by reflecting phenomenon and by heating of the outside body of said magnetron.

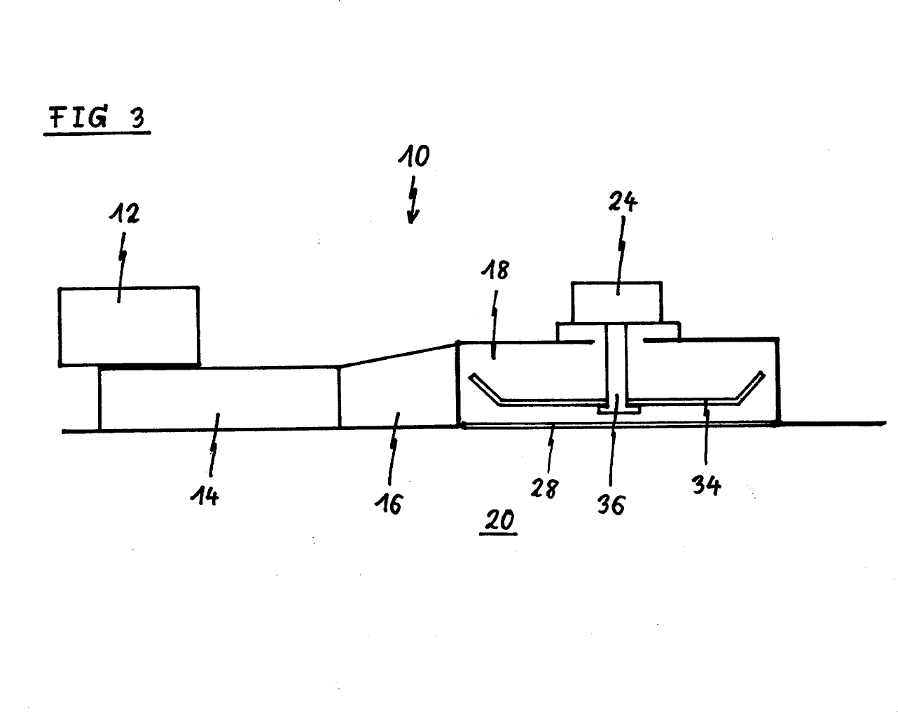

FIG. 3 illustrates a schematic sectional side view of an example of the microwave feeding system according to the prior art. The microwave feeding system 10 comprises a magnetron 12, a rectangular waveguide 14, a Chebyshev waveguide transformer 16 and a cylindrical cavity 18. A wave stirrer 34 is arranged inside the cylindrical cavity 18. The wave stirrer 34 is driven by a motor 24 and connected to said motor 24 via a stirrer shaft 36. Said stirrer shaft 36 is made of dielectric material.

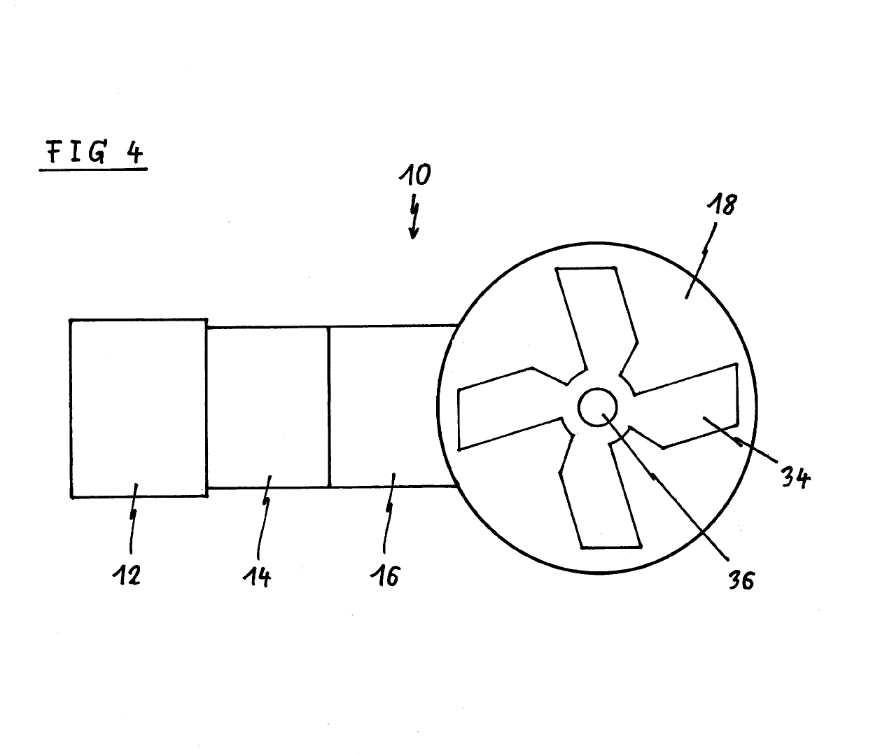

FIG. 4 illustrates a schematic sectional top view of the microwave feeding system 10 for the microwave oven according to the prior art. The wave stirrer 34 includes four stirrer blades. The wave stirrer 34 shifts the phase of the electromagnetic waves, but this is not sufficient for improving the microwave distribution, since there is a big variation of the impedance between the location point of the antenna of the magnetron 12 and the oven cavity 20. This results in an efficiency of the power consumption of not more than 50% to 55%. The blades of the wave stirrer 34 reflect a part of the microwave energy back to the antenna of the magnetron 12, so that an outer body of said magnetron 12 is heated up. The microwave feeding system 10 of the prior art generates only linearly polarized TE and TM electromagnetic waves resulting in a standing wave picture in the oven cavity 20. The only phase changing is obtained by the rotation of the wave stirrer 34, but this does not substantially improve the power distribution in the oven cavity 20 and in the load.

U.S. Pat. No. 5,204,503 discloses a microwave oven, wherein the microwave feeding system comprises a magnetron, a rectangular waveguide and a cylindrical cavity. A rotatable antenna and an inner cavity are arranged inside the cylindrical cavity. The waveguide extends horizontally. The cylindrical cavity is arranged beneath said waveguide.

FR 2 410 414 A1 discloses a microwave oven, wherein the microwave feeding system comprises a magnetron, a rectangular waveguide and a cylindrical cavity. A rotatable antenna is arranged inside the cylindrical cavity. The waveguide extends horizontally. The rotatable antenna is arranged above said waveguide.

It is an object of the present invention to provide a microwave feeding system for a microwave oven, which optimizes the power transfer from the magnetron to the oven cavity.

The object is achieved by the microwave feeding system according to claim 1.

According to the present invention the magnetron, the rectangular waveguide and the cylindrical cavity are connected in straight series, wherein the microwave feeding system provides elliptically polarized TEM electromagnetic waves for the oven cavity, and wherein the omnidirectional antenna acts as a continuous phase shifter, and wherein an inner diameter of the cylindrical cavity is between 0.75 and three multiples of the wavelength of the microwaves guided within said cylindrical cavity.

The core of the present invention is the cylindrical cavity, the inner cavity and the shaft arranged coaxially to each other on the one hand and the arrangement of the magnetron, the rectangular waveguide and the cylindrical cavity in straight series on the other hand. The microwave feeding system increases the energy transfer to the oven cavity by the elliptically polarized electromagnetic waves. The uniformity and density of the power of the electromagnetic field in the oven cavity and in the load of said oven cavity is significantly improved. The efficiency of the real power absorbed by the load in relation to the microwave power delivered by the magnetron is more than 80%. The efficiency of the real power absorbed by the load in relation to the main power supply is about 60%. Thus, the power consumption is reduced.

Preferably, a Chebyshev waveguide transformer is interconnected between the rectangular waveguide and the cylindrical cavity.

In particular, the omnidirectional antenna is a quadrupole antenna and includes four blades.

For example, the blades of the omnidirectional antenna extend within one plane.

Further, the plane of the blades of the omnidirectional antenna may extend parallel to a longitudinal axis of the rectangular waveguide.

Moreover, the plane of the blades of the omnidirectional antenna may extend perpendicular to a the rotation axis of said omnidirectional antenna.

Preferably, the omnidirectional antenna and the shaft are formed as a single-piece part.

For example, the omnidirectional antenna and/or the shaft are made of metal, in particular made of stainless steel or aluminmium.

Preferably, an inner diameter of the cylindrical cavity is between 1.5 and two multiples of the wavelength of the microwaves guided within said cylindrical cavity.

Further, the rotation axis of the omnidirectional antenna may correspond with the symmetry axis of the cylindrical cavity. Thus, the omnidirectional antenna is in the centre of the cylindrical cavity. This results in symmetry of the output stage of the microwave feeding system.

In particular, the inner cavity is formed as a cylinder barrel, wherein preferably an inner diameter of the inner cavity is between 1.1 and five multiples, in particular between two and four multiples, of the diameter of the shaft enclosed by said inner cavity. In this case, the inner cavity has the same shape as the cylindrical cavity. This contributes to the symmetry of the output stage of the microwave feeding system.

Moreover, the microwave feeding system may comprise at least one choke filter arranged between the antenna motor and the cylindrical cavity.

Furthermore, the microwave feeding system may comprise at least one cover plate made of dielectric material and arranged or arrangeable between the cylindrical cavity and the oven cavity. The cover plate made of dielectric material protects the inner space of the cylindrical cavity on the one hand and lets pass the electromagnetic waves from the cylindrical cavity to the oven cavity.

Preferably, the rectangular waveguide, the Chebyshev waveguide transformer, the cylindrical cavity, the inner cavity and/or the choke filter are made of metal, in particular made of stainless steel and/or aluminium.

Further, the present invention relates to a microwave oven or an oven with microwave heating functions, wherein the microwave oven or the oven with microwave heating function, respectively, comprises at least one microwave feeding system mentioned above.

In particular, the microwave feeding system is arranged inside a wall of an oven cavity, preferably inside a top wall of said oven cavity.

Novel and inventive features of the present invention are set forth in the appended claims.

The present invention will be described in further detail with reference to the drawings, in which

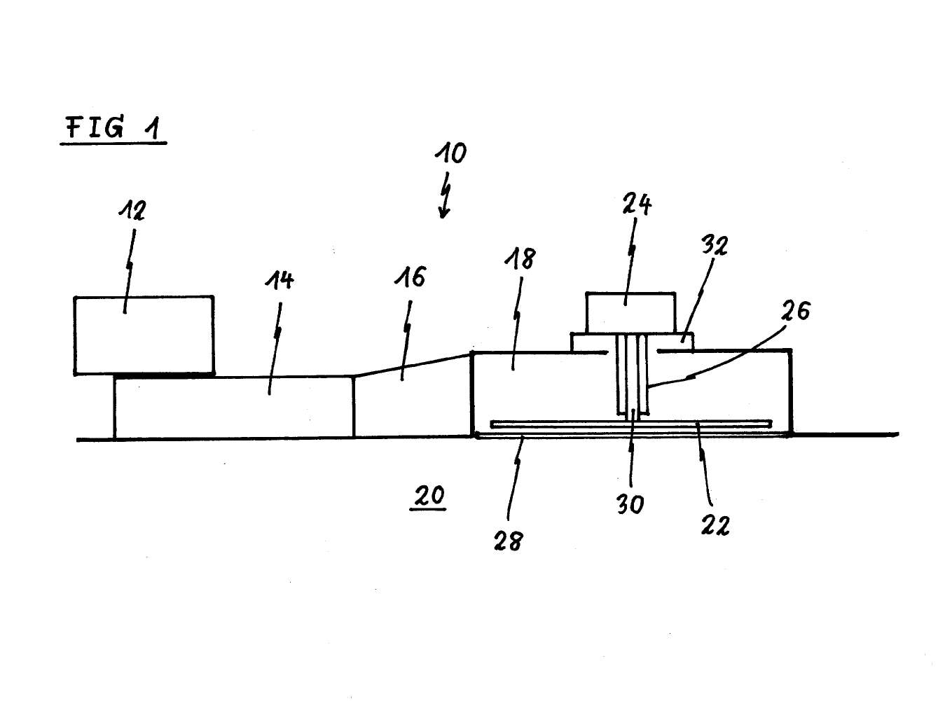

FIG. 1 illustrates a schematic sectional side view of a microwave feeding system for a microwave oven according to a preferred embodiment of the present invention,

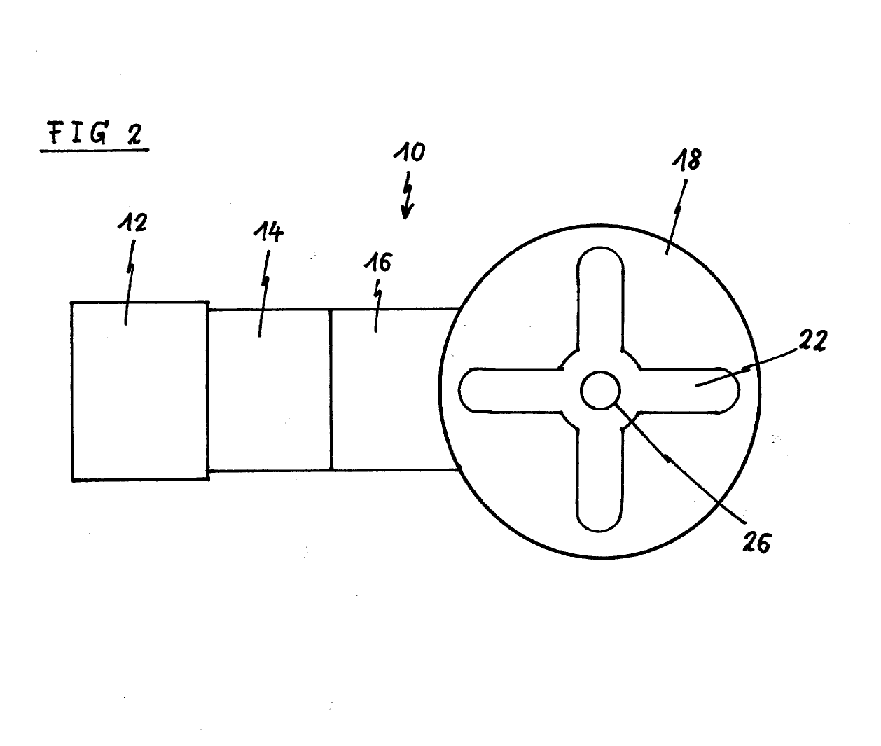

FIG. 2 illustrates a schematic sectional top view of the microwave feeding system for the microwave oven according to the preferred embodiment of the present invention,

FIG. 3 illustrates a schematic sectional side view of the microwave feeding system for the microwave oven according to the prior art, and

FIG. 4 illustrates a schematic sectional top view of the microwave feeding system for the microwave oven according to the prior art.

FIG. 1 illustrates a schematic sectional side view of a microwave feeding system 10 for a microwave oven according to a preferred embodiment of the present invention. In this example, the microwave feeding system 10 is arranged inside a top wall of an oven cavity 20. In general, the microwave feeding system 10 may be arranged with an arbitrary wall of the oven cavity of a microwave oven or an oven with microwave heating functions.

The microwave feeding system 10 comprises a magnetron 12, a rectangular waveguide 14, a Chebyshev waveguide transformer 16 and a cylindrical cavity 18. The magnetron 12 is connected to the rectangular waveguide 14, wherein a magnetron antenna penetrates into the rectangular waveguide 14. The Chebyshev waveguide transformer 16 is connected to the rectangular waveguide 14 and arranged opposite to the magnetron 12. The cylindrical cavity 18 is connected to the Chebyshev waveguide transformer 16. Thus, the magnetron 12, the rectangular waveguide 14, the Chebyshev waveguide transformer 16 and the cylindrical cavity 18 are connected in series. The rectangular waveguide 14, the Chebyshev waveguide transformer 16 and the cylindrical cavity 18 are made of metal, for example stainless steel or aluminium.

A rotational omnidirectional antenna 22 is arranged inside the cylindrical cavity 18. The rotation axis of the omnidirectional antenna 22 corresponds with the symmetry axis of the cylindrical cavity 18. Since the microwave feeding system 10 is arranged inside a top wall of an oven cavity 20, the rotation axis of the omnidirectional antenna 22 is vertical. In this example, the omnidirectional antenna 22 is a quadrupole antenna and includes four blades. The omnidirectional antenna 22 is driven by an antenna motor 24. In this example, the antenna motor 24 is arranged above the cylindrical cavity 18. A shaft 30 is interconnected between the antenna motor 24 and omnidirectional antenna 22. The shaft 30 is made of a conductive material. For example, the shaft 30 and the omnidirectional antenna 22 are formed as a single-piece part. Preferably, the shaft 30 and the omnidirectional antenna 22 are made of metal, for example stainless steel or aluminium.

An inner cavity 26 is arranged inside the cylindrical cavity 18. The inner cavity 26 is arranged coaxial to the cylindrical cavity 18. Preferably, the inner cavity 26 is formed as a cylinder barrel. The inner cavity 26 encloses the shaft 30. The inner cavity 26 and the shaft 30 are arranged coaxially to each other. The inner cavity 26 is made of metal, for example stainless steel or aluminium. Preferably, the inner diameter of the inner cavity 26 is between 1.1 and five multiples of the diameter of the shaft 30 enclosed by said inner cavity 26. In particular, the inner diameter of the inner cavity 26 may be between two and four multiples of the diameter of the shaft 30 enclosed by said inner cavity 26.

Further, a cover plate 28 is arranged between the cylindrical cavity 18 and the oven cavity 20. Said cover plate 28 is made of a dielectric material. In particular, the cover plate 28 protects the omnidirectional antenna 22 and the inner cavity 26.

Moreover, a choke filter 32 is arranged between the antenna motor 24 and the cylindrical cavity 18. Said choke filter 32 has a cylindrical shape and is arranged coaxially to the cylindrical cavity 18. The choke filter 32 avoids that microwave energy escapes through the antenna motor 24.

FIG. 2 illustrates a schematic sectional top view of the microwave feeding system 10 for the microwave oven according to the preferred embodiment of the present invention. In particular,

FIG. 2 clarifies the arrangement of the magnetron 12, the rectangular waveguide 14, the Chebyshev waveguide transformer 16 and the cylindrical cavity 18. Preferably, the inner diameter of the cylindrical cavity 18 is between 0.75 and three multiples of the wavelength of the microwaves guided within said cylindrical cavity 18. In particular, the inner diameter of the cylindrical cavity 18 may be between 1.5 and two multiples of the wavelength of the microwaves guided within said cylindrical cavity 18.

The magnetron 12 is connected to the rectangular waveguide 14. The Chebyshev waveguide transformer 16 is connected to the rectangular waveguide 14 and arranged opposite to the magnetron 12. In turn, the cylindrical cavity 18 is connected to the Chebyshev waveguide transformer 16. The magnetron 12, the rectangular waveguide 14, the Chebyshev waveguide transformer 16 and the cylindrical cavity 18 are connected in series. In this example, the omnidirectional antenna 22 includes four blades. The inner cavity 26 is arranged coaxially to the cylindrical cavity 18.

The microwave feeding system 10 of the present invention provides elliptically polarized TEM electromagnetic waves for the oven cavity 20. The omnidirectional antenna 22 acts as a continuous phase shifter.

The inner cavity 26 acts additionally as a microwave choke filter, which avoids that microwave energy escapes to the antenna motor 24. Further, the inner cavity 26 provides an attenuation of more than 90% for the main working frequency. Usually, the main working frequency of the magnetron 12 is 2.45 GHz.

The microwave feeding system 10 of the present invention increases the energy transfer to the oven cavity 20 by the elliptically polarized electromagnetic waves. The electric field vector extends parallel to the bottom wall of the oven cavity 20. The uniformity and density of the power of the electromagnetic field in the oven cavity 20 and in the load of said oven cavity 20 is significantly improved. The efficiency of the real power absorbed by the load in relation to the microwave power delivered by the magnetron 12 is more than 80%. The efficiency of the real power absorbed by the load in relation to the main power supply is about 60%. Thus, the power consumption is reduced. The distribution of the microwave field in the oven cavity 20 is improved.

FIG. 3 illustrates a schematic sectional side view of the microwave feeding system 10 for the microwave oven according to the prior art.

The microwave feeding system 10 of the prior art comprises the magnetron 12, the rectangular waveguide 14, the Chebyshev waveguide transformer 16 and the cylindrical cavity 18. The magnetron 12 is connected to the rectangular waveguide 14. The Chebyshev waveguide transformer 16 is connected to the rectangular waveguide 14 and arranged opposite to the magnetron 12. The cylindrical cavity 18 is connected to the Chebyshev waveguide transformer 16. Thus, the magnetron 12, the rectangular waveguide 14, the Chebyshev waveguide transformer 16 and the cylindrical cavity 18 are connected in series. The rectangular waveguide 14, the Chebyshev waveguide transformer 16 and the cylindrical cavity 18 are made of metal, for example stainless steel or aluminium.

A wave stirrer 34 is arranged inside the cylindrical cavity 18. The rotation axis of the wave stirrer 34 corresponds with the symmetry axis of the cylindrical cavity 18. The wave stirrer 34 is connected to the motor 24 via a stirrer shaft 36. Said stirrer shaft 36 is made of dielectric material.

FIG. 4 illustrates a schematic sectional top view of the microwave feeding system 10 for the microwave oven according to the prior art. The wave stirrer 34 includes four stirrer blades. The wave stirrer 34 shifts the phase of the electromagnetic waves, but this is not sufficient for improving the microwave distribution, since there is a big variation of the impedance between the location point of the antenna of the magnetron 12 and the oven cavity 20. This results in an efficiency of the power consumption of not more than 50% to 55%. The blades of the wave stirrer 34 reflect a part of the microwave energy back to the antenna of the magnetron 12, so that an outer body of said magnetron 12 is heated up. The microwave feeding system 10 of the prior art generates only linearly polarized TE and TM electromagnetic waves resulting in a standing wave picture in the oven cavity 20. Said electromagnetic waves are vertically and horizontally polarized. The only phase changing is obtained by the rotation of the wave stirrer 34, but this does not substantially improve the power distribution in the oven cavity 20 and in the load.

Although an illustrative embodiment of the present invention has been described herein with reference to the accompanying drawings, it is to be understood that the present invention is not limited to that precise embodiment, and that various other changes and modifications may be affected therein by one skilled in the art without departing from the scope or spirit of the invention. All such changes and modifications are intended to be included within the scope of the invention as defined by the appended claims.

### LIST OF REFERENCE NUMERALS

10 microwave feeding system
12 magneton
14 rectangular waveguide
16 Chebyshev waveguide transformer
18 cylindrical cavity
20 oven cavity
22 omnidirectional antenna
24 antenna motor, motor
26 inner cavity
28 cover plate
30 shaft
32 choke filter
34 wave stirrer
36 stirrer shaft

1. A microwave feeding system for a microwave oven or an oven with microwave heating function, wherein:
the microwave feeding system comprises a magnetron, a rectangular waveguide and a cylindrical cavity,
the cylindrical cavity is connected or connectable to an oven cavity,
a rotatable omnidirectional antenna is arranged inside the cylindrical cavity,
the omnidirectional antenna is driven by an antenna motor,
the omnidirectional antenna is connected to the antenna motor via a shaft made of conductive material,
an inner cavity is arranged inside the cylindrical cavity,
the inner cavity is arranged coaxially to the cylindrical cavity,
the inner cavity encloses at least partially the shaft, and
the inner cavity and the shaft are arranged coaxially to each other,
wherein the magnetron, the rectangular waveguide and the cylindrical cavity are connected in straight series, wherein the microwave feeding system provides elliptically polarized TEM electromagnetic waves for the oven cavity, and wherein the omnidirectional antenna acts as a continuous phase shifter, and wherein an inner diameter of the cylindrical cavity is between 0.75 and three multiples of a wavelength of microwaves guided within said cylindrical cavity.

2. The microwave feeding system according to claim 1, wherein a Chebyshev waveguide transformer is interconnected between the rectangular waveguide and the cylindrical cavity.

3. The microwave feeding system according to claim 1, wherein the omnidirectional antenna is a quadrupole antenna and includes four blades.

4. The microwave feeding system according to claim 3, wherein the blades of the omnidirectional antenna extend within one plane.

5. The microwave feeding system according to claim 4, wherein the plane of the blades of the omnidirectional antenna extends parallel to a longitudinal axis of the rectangular waveguide.

6. The microwave feeding system according to claim 4, wherein the plane of the blades of the omnidirectional antenna extends perpendicular to a rotation axis of said omnidirectional antenna.

7. The microwave feeding system according to claim 1, wherein the omnidirectional antenna and the shaft are formed as a single-piece part.

8. The microwave feeding system according to claim 1, wherein an inner diameter of the cylindrical cavity is between 1.5 and two multiples of the wavelength of the microwaves guided within said cylindrical cavity.

9. The microwave feeding system according to claim 1, wherein a rotation axis of the omnidirectional antenna corresponds with a symmetry axis of the cylindrical cavity.

10. The microwave feeding system according to claim 1, wherein the inner cavity is formed as a cylinder barrel, wherein an inner diameter of the inner cavity is between 1.1 and five multiples of the a diameter of the shaft enclosed by said inner cavity.

11. The microwave feeding system according to claim 1, further comprising at least one choke filter arranged between the antenna motor and the cylindrical cavity.

12. The microwave feeding system according to claim 1, further comprising at least one cover plate made of dielectric material and arranged or arrangeable between the cylindrical cavity and the oven cavity.

13. The microwave feeding system according to claim 2, wherein the rectangular waveguide, further comprising at least one choke filter arranged between the antenna motor and the cylindrical, the Chebyshev waveguide transformer, the cylindrical cavity, the inner cavity and/or the choke filter are made of metal.

14. A microwave oven or an oven with microwave heating function, comprising the microwave feeding system according to claim 1.

15. The microwave oven or oven with microwave heating function according to claim 14, wherein the microwave feeding system is arranged inside a wall of an oven cavity.

16. A microwave feeding system for a microwave oven or an oven with microwave heating function, said feeding system being disposed in a wall of an oven cavity and comprising:
a magnetron, a rectangular wave guide and a cylindrical cavity all made of metal and all connected in series, the magnetron having a magnetron antenna that penetrates into the rectangular wave guide,
a rotational omnidirectional quadrupole antenna arranged inside said cylindrical cavity and having a rotation axis corresponding with a symmetry axis of said cylindrical cavity, said antenna being driven by a motor arranged above the cylindrical cavity, a shaft interconnecting said motor and said antenna, said antenna and said shaft both being formed from metal, said antenna having four coplanar blades extending in a plane that is parallel to a longitudinal axis of said rectangular wave guide and perpendicular to said rotation axis, said antenna in operation being effective to act as a continuous phase shifter for microwaves in said cylindrical cavity, an inner diameter of said cylindrical cavity being 1.5-2 times a wavelength of said microwaves to be guided within said cylindrical cavity;
an inner cavity formed as a cylindrical metal barrel and arranged inside said cylindrical cavity, said inner cavity being coaxial to said cylindrical cavity and enclosing said shaft, an inner diameter of said inner cavity being 2-4 times a diameter of said shaft; and
a choke filter having a cylindrical shape and being arranged between said motor and said cylindrical cavity, said choke filter being coaxial to said cylindrical cavity;
wherein in operation the microwaves emanating from said cylindrical cavity into said oven cavity are elliptically polarized TEM electromagnetic waves whose electric field vector extends parallel to a bottom wall of the oven cavity;
and wherein in operation an efficiency of real power absorbed by a load within said oven cavity relative to microwave power delivered by the magnetron is more than 80%.

17. The microwave feeding system for a microwave oven or oven with microwave heating function according to claim 16, wherein in operation an efficiency of said real power to a main supplied to said magnetron for generating said microwave power is about 60%.
